(19) United States
(12) Patent Application Publication
(10) Pub. No.: US 2015/0004256 A1
(43) Pub. Date: Jan. 1, 2015

(54) METHOD AND APPARATUS FOR DISINFECTING SEWAGE SLUDGE

(71) Applicant: Reima PYY, Ristiina (FI)

(72) Inventor: Reima Pyy, Ristiina (FI)

(21) Appl. No.: 14/375,068

(22) PCT Filed: Feb. 1, 2013
(86) PCT No.: PCT/FI2013/050110

§ 371 Date: Jul. 28, 2014

(30) Foreign Application Priority Data
Feb. 3, 2012 (FI) 20125121

(51) Int. Cl. C02F 1/50; A01N 37/16; A01N 59/06

(52) U.S. Cl. CPC C02F 1/50; A01N 59/06; A01N 37/16; C02F 2303/04; C02F 2305/00
USPC 424/688; 210/209; 210/219

(57) ABSTRACT

A method and an apparatus for disinfecting sewage sludge are disclosed, in which sewage sludge is loaded from a silo into an open container, the open container is transferred away from the loading site, a granular calcium oxide (CaO) is dispensed into the sludge, a diluted peracetic acid solution is dispensed into the sludge and the sludge is mixed in the open container by at least four horizontal mixing screws for about two hours.

### CROSS-REFERENCE TO RELATED APPLICATIONS

This application is a National Stage application of International Application No. PCT/FI2013/050110, filed Feb. 1, 2013, which claims benefit to Finnish Application No. FI 20125121, filed Feb. 3, 2012, which are incorporated by reference herein in their entirety.

### BACKGROUND

1. Field

The invention relates to a method for disinfecting sewage sludge. The invention further relates to an apparatus for disinfecting sewage sludge.

2. Description of the related art

In water supply and at wastewater treatment plants large quantities of sludge are produced every year when water is treated. About 850 000 tons may be given as an example value. The above figure corresponds to 160 000 tons when converted to dry matter. The above numeral values are presented to illustrate the amounts of sludge at the level of year 2007, and it may be assumed that today the amount is higher than that.

Sludges produced in connection with wastewater treatment are used as soil conditioners and fertilizers, for instance. However, sludges may not be used as such, but the sludges must be treated first before they can be used as fertilizers, for instance. The use of sludges is controlled by means of legislation and various regulations.

Treatment of sludge is one of the most difficult and most expensive stages in wastewater treatment, even though basically the question is about simple matters such as elimination of elements hazardous to human health or the environment and the like. Elimination of harmful pathogens and salmonella bacteria, or at least reduction in their quantities to be within allowed limits, may be given as examples.

Bacterial content in the described sludge is extremely high, so it cannot be used as such as a fertilizer, for instance, or as covering layers on landfills, for instance. For the described sludge the most commonly used further processing method is windrow or reactor composting.

A drawback with the composting technique is that it is slow, in other words, the process takes several weeks and not until after said process of long duration the sludge may be transported to a field, for instance. An example of the slowness of the process is curing after pre-composting, which curing takes place in a covered space or in an open field. In the curing stage the compost is turned over at an interval of about 1 to 4 weeks to begin with, and as the curing of the compost progresses the turning interval becomes longer. In this connection it should be noted that the above example relates to one step in the composting process, the pre-composting also takes time.

The above details entails that the cost efficiency of the prior art technology is not so good as possible.

### SUMMARY

The object of the invention is to provide a method and an apparatus by which the prior-art disadvantages can be eliminated. This is achieved by a method and an apparatus of the invention. The method of the invention is characterized by loading sewage sludge from a silo into an open container, transferring the open container from the loading site, dispensing a granular calcium oxide (CaO) into the sludge, dispensing a diluted solution of peracetic acid into the sludge and mixing the sludge in the open container by means of at least four horizontal mixing screws for about two hours. The apparatus of the invention, in turn, is characterized by comprising an open container, in the interior of which container at least four mixing screws are arranged, a container for ready-to-use solution and an acid spray system connected to the container for ready-to-use solution for feeding the peracetic acid solution from the container for ready-to-use solution into the sludge in the open container.

Primarily, an advantage with the invention is improved cost efficiency over the prior art technology. When the method of the invention is employed, the sludge may be transported directly after disinfection, for instance, to a field edge to provide a storage heap for final use. Thus, storage fields required for long-term composting of the sludge at the sludge processing site will be omitted or at least reduced in a substantial manner over the prior-art composting technique.

### BRIEF DESCRIPTION OF THE DRAWINGS

The invention will be explained in the following in more detail by means of the example shown in the attached drawing, in which

FIG. 1 is a schematic view of a typical wastewater treatment plant, FIG. 2 shows a schematic side view of an embodiment of an apparatus according to the invention,

FIG. 3 is a front view of the embodiment shown in FIG. 2, FIG. 4 is a table showing the highest allowed heavy metal concentrations in soil conditioners and the measured concentrations in a sample taken from sludge treated by the method and the apparatus of the invention, and

FIG. 5 is a table showing the highest allowed concentrations of pathogens and other micro-organisms and the measured concentrations in a sample taken from sludge treated by the method and the apparatus of the invention.

### DETAILED DESCRIPTION

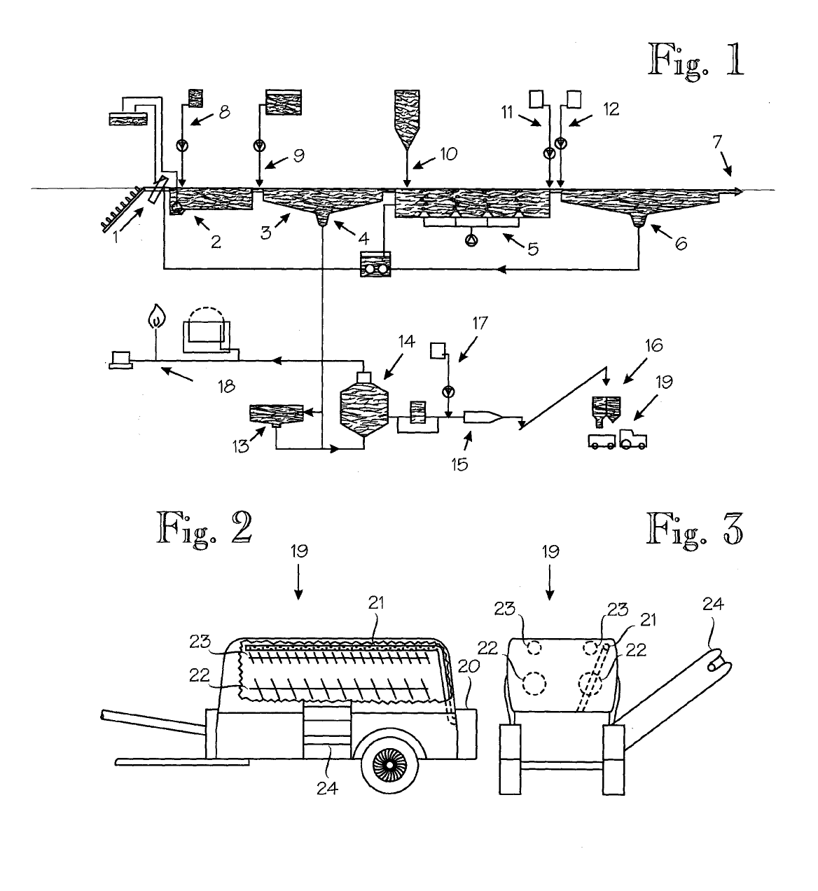

FIG. 1 shows a schematic principle of a typical wastewater treatment plant. Wastewater to be treated runs from left to right in FIG. 1. Reference numeral 1 denotes a screening step, which is first in the process, and further in the running direction of the water to be treated reference numeral 2 denotes a sand separation step, reference numeral 3 denotes preprecipitation, reference numeral 4 denotes preliminary clarification, reference numeral 5 denotes aeration and reference numeral 6 denotes final clarification. Conveyance of treated water to a water system is indicated by reference numeral 7 in FIG. 1.

In different steps of water treatment various substances are also added to the water to be treated. In the example of FIG. 1, reference numeral 8 denotes ferrous sulphate feed, reference numeral 9 polyaluminium chloride feed, reference numeral 10 lime feed, reference numeral 11 ferrous sulphate feed and reference numeral 12 polymer feed.

Sludge produced in connection with the preliminary clarification 4 is conveyed to a condensation step 13, a digestion step 14, a drying step 15 and further to storage 16, for instance. In connection with drying, a drying polymer is also introduced into the sludge in the example of FIG. 1. This step is indicated by reference numeral 17 in FIG. 1. The gas produced in connection with digestion is conveyed to gas combustion 18 in the example of FIG. 1.

The structure and operation of the example shown in FIG. 1 are known technology to a person skilled in the art, so they are not presented in any greater detail in this connection.

The method and the apparatus of the invention relate to sludge treatment after the drying step 15. By means of the invention a soil conditioner is produced from sewage sludge through disinfection, whereby hazardous pathogens, salmonella and the like hazardous elements are removed from the sludge by an oxidation/acidification process. The invention employs an apparatus configured for sludge treatment, which apparatus may be made into a trailer drawn by a tractor or another similar traction engine. FIG. 1 shows, in principle, that the sludge is conveyed after the drying step 15 into a silo used as a storage space 16, for instance. The apparatus of the invention is denoted, in principle, by reference numeral 19 in FIG. 1. The apparatus 19 of the invention is shown in greater detail in FIGS. 2 and 3.

In accordance with the basic idea of the invention, the apparatus 19 of the invention, e.g. a trailer shown in FIGS. 2 and 3, comprising a container with an open top, is steered under the silo serving as the storage space 16 and a suitable quantity of sludge is discharged into the container. The above-mentioned container may be provided in such a way that the opentop cargo space of the trailer constitutes the container. The capacity of the container may vary freely according to need. Container capacity of 20 m³ may be given as an example, in which case about 10 to 20 tons of sludge may be discharged from the silo into the space concerned. If so desired, the trailer may also be furnished with a weighing appliance, by means of which the amount of sludge to be fed into the trailer may be controlled.

After sludge loading the trailer is moved away from the silo, for instance to an outdoor location, where disinfection is performed on the sludge. In connection with the disinfection, a granular calcium oxide (CaO) is dispensed in appropriate proportion into the sludge. Dispensing may take place in any appropriate manner. Use of a big bag discharger from a big bag of 1000 kgs into the sludge may be given as an example.

A diluted solution of peracetic acid (C2H4O3 solution) is additionally dispensed into the sludge. The dispensing of the peracetic acid may take place from a ready-to-use solution container 20 arranged on the trailer, for instance, by employing an acid spray system 21 connected to the ready-to-use solution container. The acid spray system comprises a pump, a pipework and a nozzle arrangement, and naturally also an operating and control system. The nozzle arrangement may be provided by longitudinal pipes arranged in trailer edges, in which pipes an appropriate number of nozzles of suitable size have been arranged. As an example may be given 6 nozzles of 25 mm. The ready-to-use solution container may be any container of appropriate size. As an example may be given a container of about 200 litres, into which is dispensed a required quantity of solution for each disinfection time in appropriate mix proportions. The dispensing may be carried out according to a batch dispensing principle.

The sludge is mixed in the open container by means of at least four horizontal mixing screws 22, 23. The mixing time of the sludge is about 2 hours. After mixing the sludge may be transferred onto a suitable vehicle for transport. The transfer may be carried out, for instance, by a conveyor 24 arranged on the trailer 19. The length of the conveyor 24 may be selected freely, a 3-metre long conveyor may be given as an example.

The mixing screws 22, 23 are horizontal, parallel screws that are arranged in such a way that the mixing screws 22 are lower mixing screws and the mixing screws 23 are upper mixing screws. As can be seen in FIGS. 2 and 3, the number of both lower and upper mixing screws is two each. The number of mixing screws may also be higher. The mixing screws may be rotated through the power output of a tractor, for instance. In the example of the figures, the mixing screws are screws in the longitudinal direction of the trailer. Other directions are also possible, depending on the shape of the trailer, for instance. By means of the above-described mixing screw arrangement an efficient mixing result will be achieved.

The trailer and its parts may be manufactured of steel material, for instance. The mixing screws and the whole interior of the open container may advantageously be coated with an acid-proof epoxy resin.

During dispensing the sludge is measured for a temperature and pH. Measuring may be carried out in any manner known per se. Through the above-mentioned measurings it is possible to monitor the progress of disinfection.

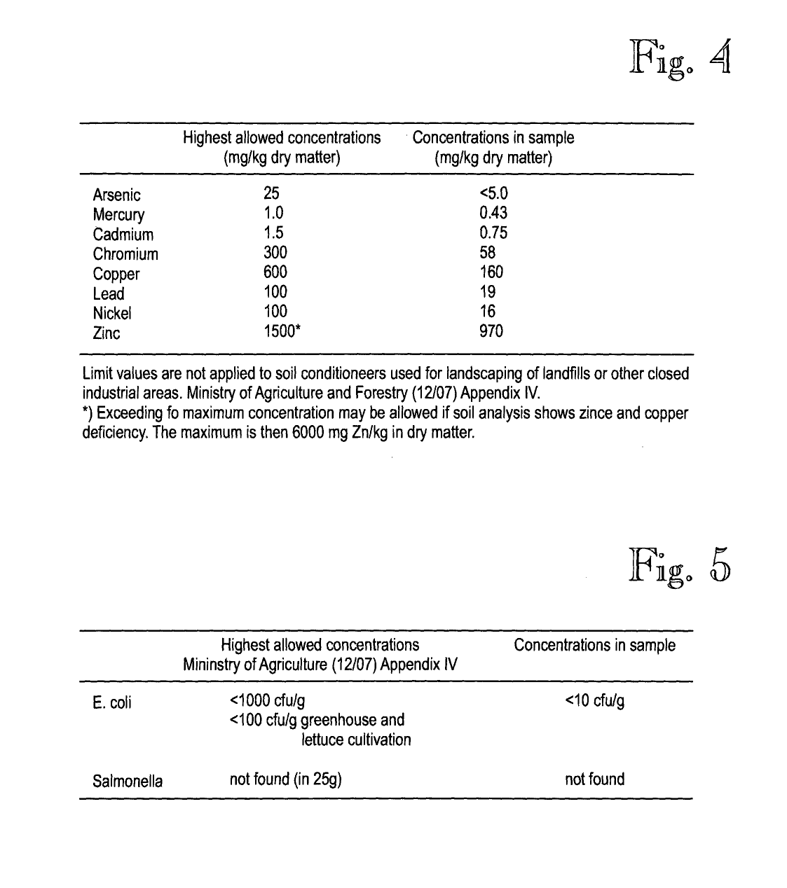

FIGS. 4 and 5 present the tables showing the highest allowed heavy metal concentrations, pathogens and other micro-organisms in soil conditioners and the results obtained by the treatment of the invention.

The above-described procedure is granted permission to allow the contractor to transport the sludge directly after disinfection to a field edge to form a storage heap for final use (Ministry of the Environment, the Finnish Food Safety Authority, the ELY Centres).

The sludge disinfection is monitored for the first four weeks on each treated sludge batch. A sample of the treated batches is forwarded to a supervisory organization, e.g. to the laboratory of Viljavuuspalvelu Oy in Mikkeli, Finland, where the treated soil conditioner is tested for E-coli and salmonella, inter alia. In case the sludge disinfection does not show any abnormalities during that time, thereafter the sampling will be performed by the contractor through random sampling, which will be agreed upon separately.

The farmer is responsible for making a storage heap and reporting the location of the sludge, for instance, using the tracing service software provided by the contractor, by means of which the farmer sends an SMS message to Viljavuuspalvelu Oy, which message contains information on the location of the sludge for mapping. The map indicates the location, composition and quantity of the soil conditioner and the time when it was received. Naturally the farmer may report said data also in another suitable manner.

The above exemplary embodiment of the invention is not intended to limit the invention in any way, but the invention may be varied entirely freely within the scope of the claims. In the example of the figures the apparatus is a trailer, whereby the mixing screws may be rotated by a motor and power output of a tractor. Naturally, this is not the only possibility, but the apparatus may be provided such that it has a power source of its own, e.g. an internal combustion engine or an electric motor. The apparatus may be stationary or movable, etc. The shape of the open container, e.g. the trailer, may vary freely according to any particular need. Naturally, the trailer may be furnished with fixed measuring devices for temperature and pH, if deemed necessary.

1. A method for disinfecting sewage sludge, which comprises:
loading sewage sludge from a silo into an open container;
transferring the open container from the loading site;
dispensing a granular calcium oxide (CaO) into the sludge;
dispensing a diluted solution of peracetic acid into the sludge and mixing the sludge in the open container by means of at least four horizontal mixing screws for about two hours.

2. The method of claim 1, further comprising determining the degree of disinfection the sludge by measuring for a temperature and pH during the dispensing.

3. The method of claim 1, further comprising loading the treated sludge onto a vehicle intended for sludge transport.

4. An apparatus to disinfect sewage sludge, which comprises:
an open container, in the interior of which container at least four mixing screws are arranged;
a ready-to-use solution container; and
an acid spray system connected to the ready-to-use solution container for feeding a peracetic acid solution from the ready-to-use solution container into the sludge in the open container.

5. The apparatus of claim 4, wherein the mixing screws comprise two lower mixing screws and two upper mixing screws.

6. The apparatus of claim 5, wherein the mixing screws are horizontal and mutually parallel screws.

7. The apparatus of claim 4, wherein the open container is a trailer with open top.

8. The apparatus of claim 4, wherein the capacity of the open container is about 20 m³ and the capacity of the ready-to-use solution container is about 200 litres.

9. The apparatus of claim 7, wherein the mixing screws are arranged for being rotated by means of the power source of the tractor vehicle of the trailer.
